(19) United States
(12) Patent Application Publication
(10) Pub. No.: US 2008/0244401 A1
(43) Pub. Date: Oct. 2, 2008

(54) User interface teaching concepts in an application

(75) Inventors: Aravind Bala, Redmond, WA (US); Karen Fries, Seattle, WA (US); Peter F. Leonard, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/732,051

(22) Filed: Apr. 2, 2007

(51) Int. Cl. G06F 3/00

(52) U.S. Cl. 715/708

(57) ABSTRACT

Various embodiments provide a wizard integrated as part of an application to assist a user in operating within the application. In one or more embodiments, the wizard comprises an inline portion of the application's user interface and is designed to enable a user to express a desired goal and then present one or more choices that appear to satisfy the user's desired goal. The choices are titled in a manner that obscures or abstracts away more complex choices and concepts with which a user may not be familiar. When the user selects a particular displayed choice, the wizard can present further choices which are progressively narrowed to focus on the user's desired goal, thus directing the user to a suitable feature to accomplish his or her goal and providing just-in-time conceptual information about the feature to enable the user to use that feature.

### BACKGROUND

Typically, software programs have many different features that a user can use. In order to use a program's features, the user must be aware that the feature exists in the program, know where it is located, understand some concepts that are implicit in how the feature works and be able to choose and distinguish between other similar-seeming features. Complicating this is the fact that many users find the current learning processes intrusive as they require the user to exit from their workspace. These learning processes can include using a program-affiliated help topic menu, navigating to a web-based help site, and/or reading a tutorial or a book.

As an example, consider the following. Assume that a user of PowerPoint software wishes to use a picture as a background of all of the slides in a presentation on which the user is working. While a feature exists to perform this function (namely, editing the Master Slide), there may be a number of hurdles that prevent a user from accessing and using this feature. Perhaps the user does not know that the Master Slide features exists. Alternately or additionally, the user may not know where to go in the user interface to invoke the feature. Further, the user may lack an understanding of the concept of a Master Slide (e.g., a Master Slide acts as a ‘parent’ to slides that inherit from it, so that any change made to the Master is automatically shown in all the slides of which it is the Master). Without understanding this concept, a user will, no doubt, have trouble using the feature. Further, there may be other features that seem like likely candidates to accomplish the user's goal (e.g. setting the background color, inserting a picture, choosing a style, choosing a theme, and using a template), all of which can affect how the background of a slide looks. Yet, knowing which feature to use requires understanding the different underlying concepts.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a wizard integrated as part of an application to assist the user in operating within the application. In one or more embodiments, the wizard comprises an inline portion of the application's user interface and is designed to enable a user to express a desired goal and then present one or more choices that appear to satisfy the user's desired goal. The choices are titled in a manner that obscures or abstracts away more complex choices and concepts with which a user may not be familiar. When the user selects a particular displayed choice, the wizard can present further choices which are progressively narrowed to focus on the user's desired goal, thus directing the user to a suitable feature to accomplish his or her goal and providing just-in-time conceptual information about the feature to enable the user to use that feature.

### BRIEF DESCRIPTION OF THE DRAWINGS

The same numbers are used throughout the drawings to reference like features.

FIG. 1 illustrates a system in accordance with one or more embodiments.

FIG. 2 illustrates a user interface in accordance with one or more embodiments.

FIG. 3 illustrates a user interface in accordance with one or more embodiments.

FIG. 4 illustrates a user interface in accordance with one or more embodiments.

FIG. 5 illustrates a user interface in accordance with one or more embodiments.

FIG. 6 illustrates a user interface in accordance with one or more embodiments.

FIG. 7 illustrates a user interface in accordance with one or more embodiments.

FIG. 8 is a flow diagram that describes steps in a method in accordance with one or more embodiments.

FIG. 9 illustrates an example system that can be utilized to implement one or more embodiments.

### DETAILED DESCRIPTION

Overview

Various embodiments provide a wizard integrated as part of an application to assist the user in operating within the application. In one or more embodiments, the wizard comprises an inline portion of the application's user interface and is designed to enable a user to express a desired goal and then present one or more choices that appear to satisfy the user's desired goal. The choices are titled in a manner that obscures or abstracts away more complex choices and concepts with which a user may not be familiar. When the user selects a particular displayed choice, the wizard can present further choices which are progressively narrowed to focus on the user's desired goal, thus directing the user to a suitable feature to accomplish his or her goal and providing just-in-time conceptual information about the feature to enable the user to use that feature.

In one or more embodiments, the inline wizard is built into the user interface of the application. Accordingly, in these embodiments, the wizard is not a separate window or module such as a help menu or tutorial which, for example, would “fly in” from the side of the application's user interface. Rather, the wizard's functionality is presented as a unified and integral part of the application's user interface. Thus, from a user's perspective, the wizard is a regular, integrated part of the application.

In at least some embodiments, just-in-time conceptual information is provided in the form of a guided help mode. Guided help, in the context of the inline wizard, can be used to provide a brief tour of, and information pertaining to a user interface by having a small window move around the screen and highlight controls, explaining what they are used for and the like. Guided help, as will become apparent below, can also be used to execute a series of tasks by actually perform manipulations via the user interface while illustrating to the user how a particular operation can be performed.

In the discussion that follows, a section entitled “Example System” is provided and describes one system in which one or more embodiments can be employed. Following this, a section entitled “Example Inline Wizard User Interface” is provided and describes various characteristics of an example inline wizard in accordance with one or more embodiments. Next, a section entitled “Example Computing Device” is provided and describes a computing system that can be used to implement one or more embodiments.

Example System

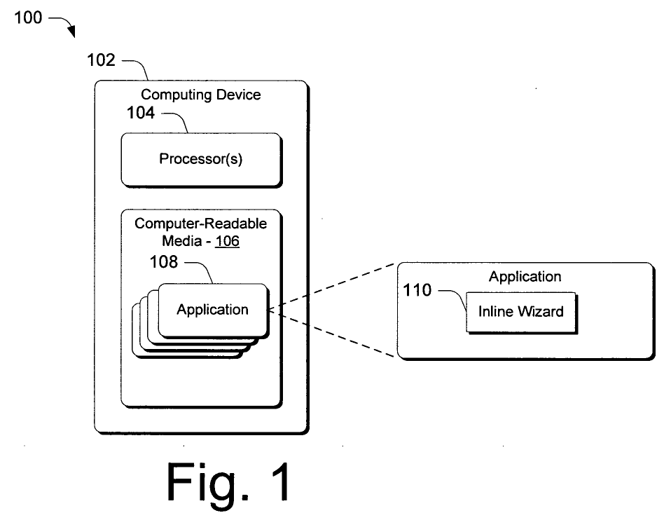

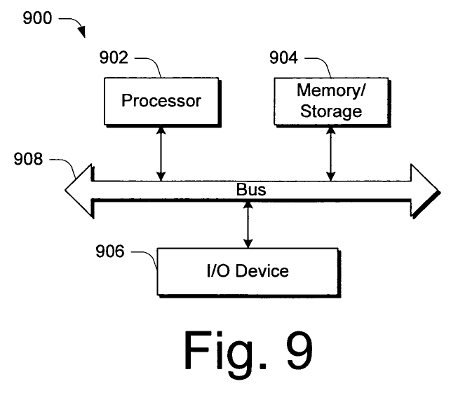

FIG. 1 illustrates a system in accordance with one or more embodiments, generally at 100. System 100 includes a computing device 102 having one or more processors 104, one or more computer-readable media 106 and one or more applications 108 that reside on the computer-readable media and which are executable by the processor(s). The computer-readable media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 9.

In one or more embodiments, individual applications 108 can include an inline wizard 110 that provides the functionality described above and below. In at least some embodiments, each application's inline wizard is integrated with and comprises part of the application. So, for example, applications such as word processing applications, spreadsheet applications, presentation development applications, computer-aided design applications and the like would all have individual inline wizards that are uniquely associated with that particular program. Alternately or additionally, the inline wizard functionality can be implemented by one or more components that are leveraged or otherwise used by an application. For example, inline wizard functionality can comprise part of an operating system and can be exposed to an application via a suitably configured application program interface (API).

By being integrated directly with and/or comprising part of an application, the user interface employed by the inline wizard can be logically and physically consistent with the look and feel of the user interface that the application employs. This helps to preserve and unify the user experience as they use the inline wizard, as will become apparent below.

Although computing device 102 is illustrated in the form of a desktop computer, it is to be appreciated and understood that other computing devices can be utilized without departing from the spirit and scope of the claimed subject matter. For example, other computing devices can include, by way of example and not limitation, portable computers, handheld computers such as personal digital assistants (PDAs), cell phones and the like.

Example Inline Wizard User Interface

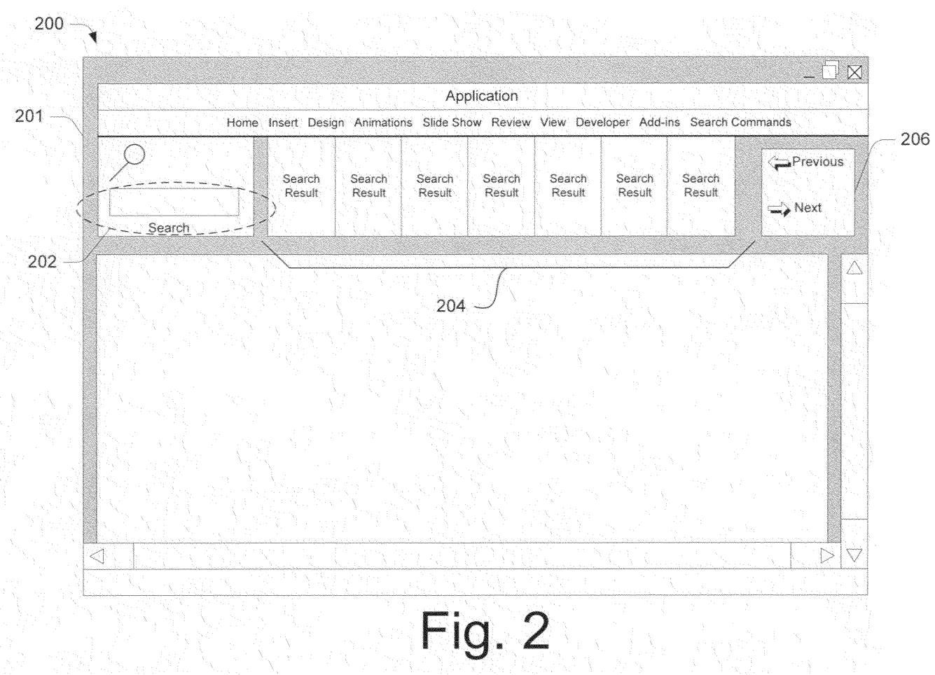

FIG. 2 illustrates, in accordance with one or more embodiments, an example application user interface 200 having an inline wizard user interface portion. The application user interface can comprise part of any suitable type of application examples of which are provided above.

In this particular example, user interface 200 is defined within a resizable, closeable window 201, and the inline wizard user interface portion comprises a means for receiving user input an example of which is illustrated at 202. There, the means for receiving user input comprises a search text box in which a user can enter text for a particular search. Alternately or additionally, the means for receiving user input can comprise voice recognition instrumentalities that can be used to enable a user to physically speak a word or phrase and then have the inline wizard conduct a search based on that word or phrase. In one or more embodiments, the means for receiving user input supports natural language such that a user can simply enter, in a natural language, a search term in which they are interested.

In addition to the illustrated search text box, the inline wizard user interface portion includes a results area 204 in which individual results from a search can be displayed for the user. In this area, multiple results can be displayed for the user. Hence, in this example, the results area is divided up into individual portions that represent an area in which an individual result can be displayed. In addition, a navigation instrumentality 206 is provided and enables the user to navigate through the various results (e.g. “previous” and “next”) that are displayed in the results area 204. For example, if the number of search results exceeds the space allocated in the results area 204, then the user can utilize the navigation instrumentality 206 to access and view the additional results.

Notice here that the inline wizard user interface portion is presented in the context of the application with which the user is working. That is, the inline wizard is integrated with the application's overall user interface so that there is a visual, logical and physical continuity between the inline wizard interface portion and the remainder of the application's user interface. The remainder of the application user interface can include those features that typically make up such an interface. For example, a bar just above the search text box and results area presents selections that enable a user to view drop down menus associated with various functionality provided by the application. Additionally, a work area just beneath the search text box and the results area provides an area in which a user can accomplish work tasks using the application.

Notice also that, in this example, at least a portion of the inline wizard interface portion is contained within the resizable, closeable window 201 of user interface 200. In one or more embodiments, the inline wizard interface portion is contained entirely within window 201 and is presented within the ribbon of the application's user interface. The ribbon comprises a strip across the top of a window that exposes an application's functionality.

In the discussion that follows, the inline wizard is described in the context of a presentation development application, such as Microsoft's PowerPoint application. It is to be appreciated and understood that other types of applications can be utilized without departing from the spirit and scope of the claimed subject matter.

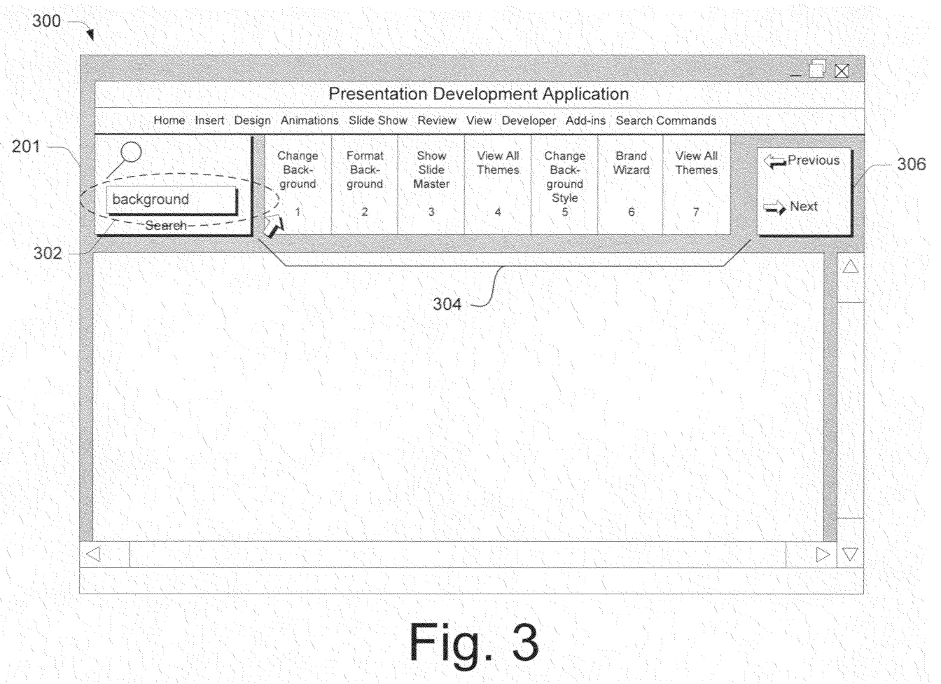

FIG. 3 illustrates, in accordance with one or more embodiments, an example presentation development application user interface 300 having an inline wizard user interface portion having a search text box 302, a results area 304 and navigation instrumentalities 306.

In this example, assume that the user is working with the presentation development application and wishes to change the background on all slides that are going to be used in the presentation. In this case, using the search text box 302, the user can simply enter a word or phrase that describes, in some way, their goal. In this particular example, the user has entered the word “background” because they wish to change the background on all of the presentation's slides. In one or more embodiments, as the user begins to enter individual letters of the term that they are entering in the search text box 302, individual results appears in the results area 304. In practice, as the user enters their search term, the inline wizard can calculate likely words that complete the letter string that the user is entering. As the likely words are calculated, the inline wizard searches for and displays search results that appear to be consistent with the user's entered text string. Any suitable method of performing such a search can be conducted. For example, the search can be performed using a trained search engine that is trained with prior probabilities associated with entered terms and search results.

Thus, responsive to receiving the user's articulated goal, the inline wizard conducts a search to identify what it believes to be relevant choices associated with the goal. In one or more embodiments, at least some of the choices that are displayed by the inline wizard are expressed in terms of goals that are consistent with the term entered by the user. Doing so obscures more complex choices and concepts that a user may not yet understand. For example, results area 304 includes a number of different choices that are displayed for the user. The choices include “Change Background”, “Format Background”, “Show Slide Master”, “View All Themes” and the like.

Some of the choices that are displayed may not necessarily be familiar to the user. For example, the choices “Show Slide Master” and “View All Themes” may require additional knowledge that the user simply does not have at this point. In this case, the user can hover their cursor over the choices to receive additional information about them. One example of this is provided below.

In addition, in at least some embodiments, choices that are presented to the user can be ranked in terms of their likely relevance to the term that was provided by the user. Any suitable method or technique can be used to rank the choices. For example, scores can be computed based on the history of returned results relative to an entered term. In the illustrated and described embodiment, the rankings can be visually presented to the user via, for example, numerals that appear in the individual search results area. Alternately or additionally, the rankings can be manifest in the order in which the individual results are displayed. In addition, it at least some embodiments, shortcut key functionality can be provided to enable a user to access their search results. For example, if the search results are ranked numerically, then the user can access a particular search result by simply entering its number in the search text box or some other area.

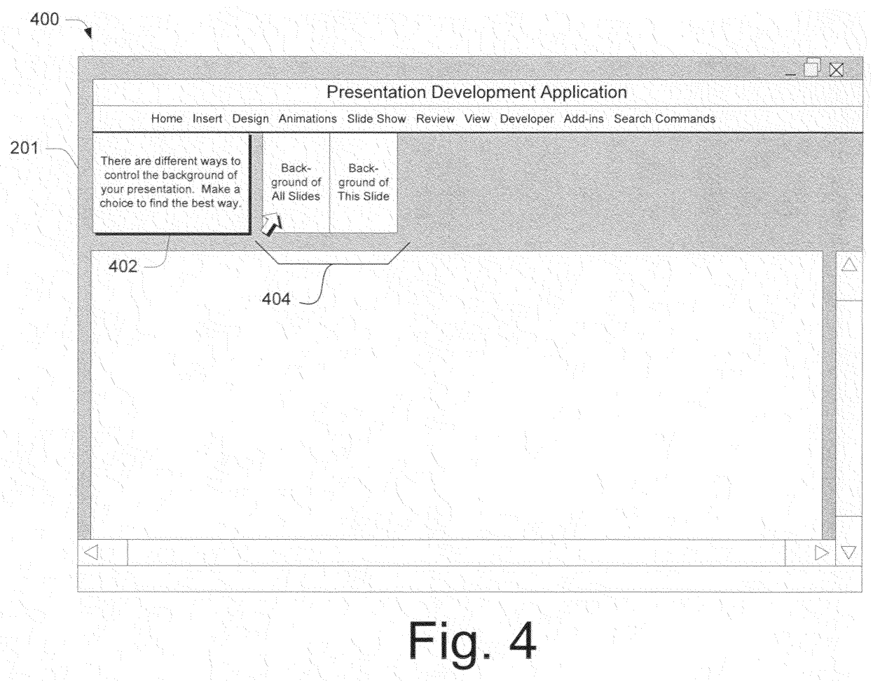

Continuing, assume in this example that the user clicks the “Change Background” choice in FIG. 3, as illustrated by the cursor overlying the “Change Background” choice. In this case, the user is presented with a user interface as shown in FIG. 4 generally at 400. In this example, results area 404 includes one or more choices that are relevant to the user's selection. Specifically, in this instance, two different choices are presented—“Background of All Slides” and “Background of This Slide”. Notice also that the choices are still expressed in terms of goals that are consistent with the term previously entered by the user, i.e. “background”. In one or more embodiments, search results can be worded in the results area using the user's own words for ease of recognition. For example, if the user searched for the term “Terminal Server”, instead of presenting a search result that read “Remote Desktop”, the term “Terminal Server” can be displayed instead. Further relevant material or information can be accessed, with respect to this search result, by using the techniques described above and below.

In addition to displaying various choices in the results area 404, an information area 402 is provided and includes additional information that pertains to the choices that are displayed for the user. In this particular example, information area 402 indicates that there are different ways to control the background of a presentation. Accordingly, the information area 402 provides additional context that is relevant to choices that are displayed for the user and helps the user understand aspects associated with the displayed choices.

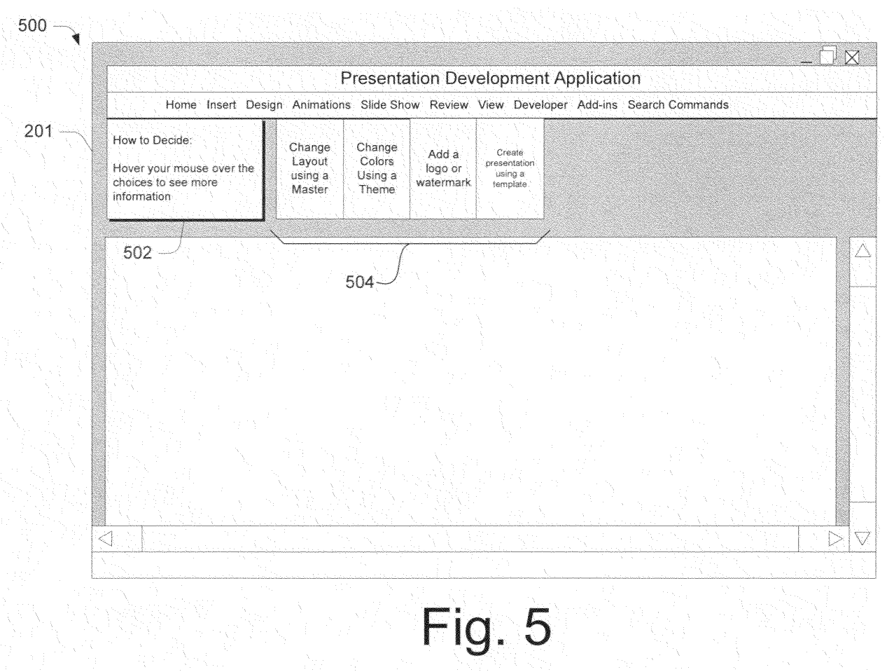

In this example, assume that the user clicks on or otherwise selects the “Background of All Slides” choice as illustrated by the cursor overlying this choice. In this case, the user might be presented with a user interface such as the one shown in FIG. 5 generally at 500. Here, results area 504 includes the next layer of choices for the user, and information area 502 includes information that is relevant to the choices that are displayed for the user. Here, the results area lists choices that include “Change Layout using a Master”, “Change Colors using a Theme”, “Add a logo or watermark” and “Create presentation using a template”. These choices introduce new concepts, but entirely in the context of the goal of changing the background for all of the slides. The information area informs the user that if they hover their mouse over a particular choice, additional information will be displayed to enable the user to make a more informed decision. This additional information can be displayed in the form of a so called tool tip.

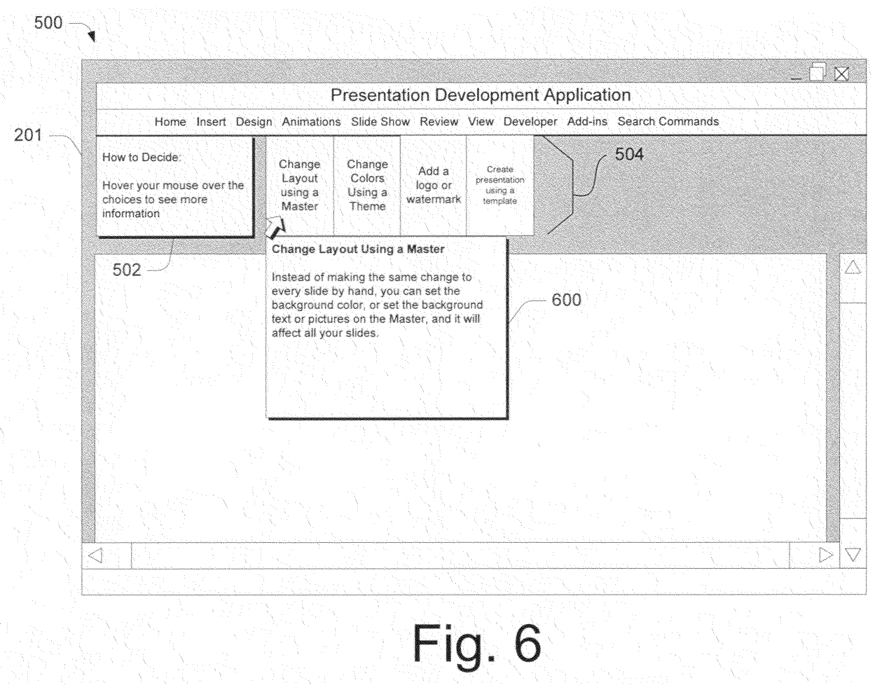

As an example, consider FIG. 6 which shows the FIG. 5 user interface 500. Here, the user has hovered their mouse over the “Change Layout using a Master” choice and, responsively, a tool tip 600 is displayed that includes additional information about changing a layout using a master.

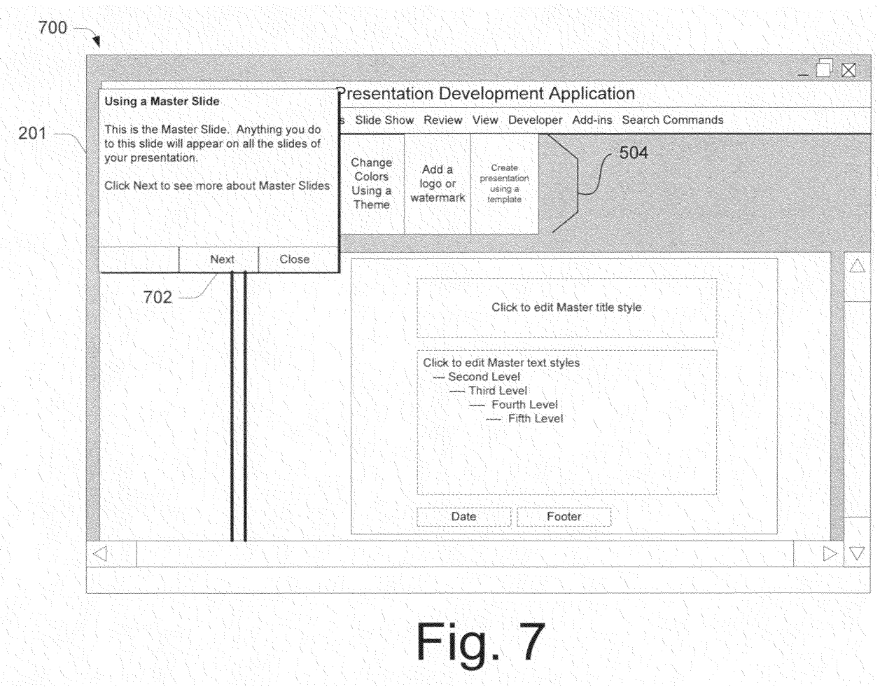

At this point, when the user clicks or otherwise selects “Change layout using a Master”, the application program switches to a Master view that enables the user to accomplish their goal of changing the background of all of their presentation's slides. Alternately or additionally, in at least some embodiments, the user interface can include guided help instructions that give some basic information about the concept of a Master view. As an example, consider FIG. 7. There, a user interface 700 is presented and includes the Master view. Notice also that guided help in the form of a floating window 702 is provided. The guided help window 702 provides information that pertains to the choice that the user has made.

In at least some embodiments, the guided help functionality can be implemented in a couple of different ways. First, once a user has selected an appropriate choice where the guided help is exposed to them, the guided help can essentially guide them through the steps that they need to accomplish in order to take a particular action. It can do this by moving window 702 around the user interface and displaying, within the window, the various user interface elements, along with various highlighting, to identify to the user the particular user interface elements that the user should select to accomplish the desired task. Alternately or additionally, the guided help functionality can essentially automatically accomplish one or more tasks that are relevant to the choice that the user has made. In at least some embodiments, as these tasks are accomplished, user interface elements are displayed and automatically engaged to illustrate to the user the steps that are used to accomplish the tasks associated with the user's choice. The “next” button allows the user to advance to the next window to walk through and/or execute the steps to accomplish their choice.

It is to be appreciated and understood that while the application wizard has been described as comprising part of the application with which it is associated and, therefore, residing on the same computing device as the application, such need not be the case. For example, it is possible for the inline wizard to have components that are remote from the computing device on which its associated application resides. In this case, the application and the inline wizard would communicate using a suitable protocol to articulate the user's choices to the wizard and, responsively, to receive back content that is to be rendered for the user as part of the wizard's functionality. This might be the case, for example, if the application's computing device was a so-called “thin client”.

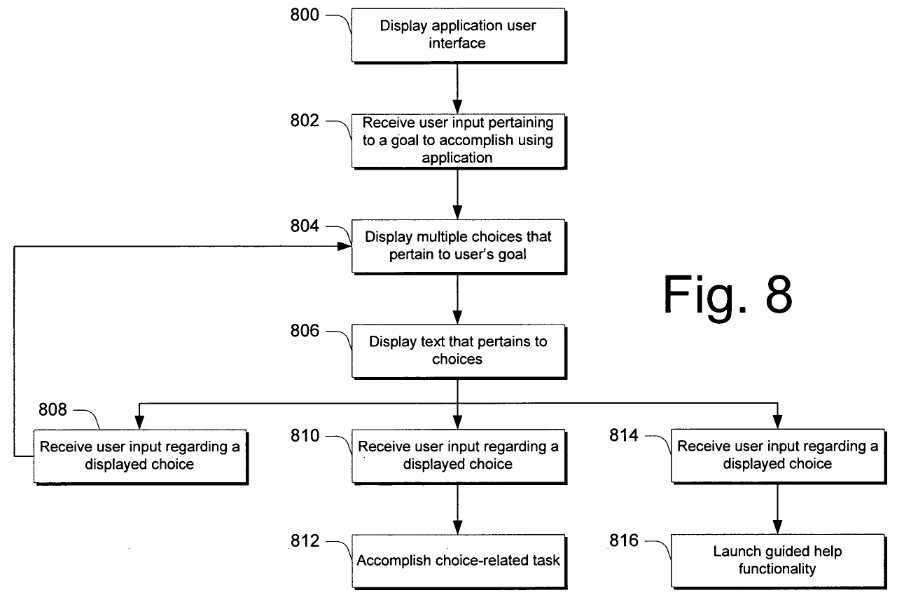

FIG. 8 is a flow diagram that describes steps in a method in accordance with one or more embodiments. The method can be performed in connection with any suitable hardware, software, firmware or combination thereof. In one or more embodiments, the method can be performed by a suitably configured inline wizard such as those described above.

Step 800 displays an application user interface. Any suitable type of application and any suitable type of user interface can be displayed. Step 802 receives user input pertaining to a goal the user wishes to accomplish using the application. Examples of how this can be done are given above. Step 804 displays, using the application's user interface, multiple choices (or one or more choices) that pertain to the user's goal. Examples of how this can be done are provided above. Step 806 displays text that pertains to the choice(s). Examples of how this can be done are given above.

In one or more embodiments, one of three different paths can be followed at this point. In connection with a first path, step 808 receives user input regarding a displayed choice. In the illustrated and described embodiment, this input can comprise the user selecting the particular choice. Responsive to the user's selection, the method loops back to step 804 to display multiple (or one or more) choices associated with the user's choice and continues with step 806. This branch of the process is similar to processing that was described above in connection with the example.

Alternately or additionally and in conjunction with a second path, step 810 receives user input regarding a displayed choice and step 812 accomplishes a choice-related task. For example, if a user selects a particular choice, they may be at a place in the process where they can now actually begin to accomplish tasks associated with their choice. At this point, appropriate user interface elements can be displayed to enable the user to accomplish tasks to complete their goal. In this example above, this branch is illustrated best by the processing that takes place in connection with FIG. 7. In this case, window 702 may or may not be displayed for the user.

Alternately or additionally, step 814 receives user input regarding a displayed choice and step 816 launches guided help functionality. Examples of how this can be done are given above. In the specific example provided above, this branch is illustrated by the processing that takes place in connection with FIG. 7 in which window 702 is displayed for the user.

Having discussed various embodiments, consider now an example computing device that can be utilized to implement the embodiments described above.

Example Computing Device

FIG. 9 illustrates an example computing device 900 that can implement the various embodiments described above. Computing device 900 can be, for example, any suitable computing device such as a client device and/or server device.

Computing device 900 includes one or more processors or processing units 902, one or more memory and/or storage components 904, one or more input/output (I/O) devices 906, and a bus 908 that allows the various components and devices to communicate with one another. Bus 908 represents one or more of any of several types of bus structures, including a memory bus or memory controller, a peripheral bus, an accelerated graphics port, and a processor or local bus using any of a variety of bus architectures. Bus 908 can include wired and/or wireless buses.

Memory/storage component 904 represents one or more computer storage media. Component 904 can include volatile media (such as random access memory (RAM)) and/or nonvolatile media (such as read only memory (ROM), Flash memory, optical disks, magnetic disks, and so forth). Component 904 can include fixed media (e.g., RAM, ROM, a fixed hard drive, etc.) as well as removable media (e.g., a Flash memory drive, a removable hard drive, an optical disk, and so forth).

One or more input/output devices 906 allow a user to enter commands and information to computing device 900, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

### CONCLUSION

Various embodiments provide a wizard integrated as part of an application to assist the user in operating within the application. In one or more embodiments, the wizard comprises an inline portion of the application's user interface and is designed to enable a user to express a desired goal and then present one or more choices that appear to satisfy the user's desired goal. The choices are titled in a manner that obscures or abstracts away more complex choices and concepts with which a user may not be familiar. When the user selects a particular displayed choice, the wizard can present further choices which are progressively narrowed to focus on the user's desired goal, thus directing the user to a suitable feature to accomplish his or her goal and providing just-in-time conceptual information about the feature to enable the user to use that feature.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
one or more computer-readable storage media;
an application embodied on the one or more computer-readable storage media;
a wizard embodied on the one or more computer-readable storage media, wherein the wizard provides an inline portion of a user interface associated with the application and is designed to enable a user to express a goal and then present one or more choices that appear to satisfy the user's goal, wherein at least some of the choices are presented within a ribbon of the application's user interface.

2. The system of claim 1, wherein the wizard is configured to, responsive to a user selecting a choice, present one or more additional choices that are in the context of the goal expressed by the user.

3. The system of claim 2, wherein the wizard is configured to, responsive to presenting one or more additional choices, present an information area that includes information that pertains to the one or more additional choices.

4. The system of claim 1, wherein the inline portion does not comprise a separate window.

5. The system of claim 1, wherein the inline portion does not fly in from a side of the user interface.

6. The system of claim 1, wherein the wizard comprises a guided help mode that is configured to provide information that pertains to a choice the user has made, wherein the information comprises at least one of:
information that guides the user through steps that are to be accomplished in order to take a particular action, or
information that automatically accomplishes one or more tasks that are relevant to the choice that the user has made.

7. The system of claim 6, wherein the guided help mode comprises a floating window.

8. The system of claim 6, wherein the guided help mode is configured to perform manipulations via the user interface to illustrate to the user how a particular operation can be performed.

9. The system of claim 1, wherein the wizard comprises a search text box in which the user can enter a term associated with the goal, and a results area adjacent the search text box in which individual results from a search can be displayed for the user.

10. The system of claim 9, wherein the user interface comprises a work area beneath the search text box and results area in which a user can accomplish work tasks using the application.

11. The system of claim 1, wherein the wizard is configured to provide additional information regarding a choice responsive to a user hovering a mouse over a presented choice.

12. The system of claim 11, wherein said additional information comprises a tool tip.

13. The system of claim 1, wherein the one or more choices comprise multiple choices which are numerically ranked.

14. A computer-implemented method comprising:
displaying an application user interface, wherein the user interface has a ribbon and is defined within a resizable, closeable window;
receiving, within the resizable, closeable window, text input by a user pertaining to a goal the user wishes to accomplish using the application; and
displaying, within the resizable, closeable window, one or more choices that pertain to the user's goal, wherein the act of displaying is performed by displaying the one or more choices in the ribbon of the user interface.

15. The system of claim 14 further comprising displaying additional text that pertains to the one or more choices, wherein the additional text is displayed inline with the application user interface.

16. The system of claim 15, wherein the act of displaying additional text is performed responsive to hovering a mouse over a particular choice.

17. The system of claim 15, wherein the act of displaying additional text is performed by displaying a tool tip.

18. The system of claim 15, wherein the act of displaying additional text is performed by displaying a guided help window.

19. One or more computer-readable storage media comprising computer-readable instructions which, when executed, are configured to provide an application user interface with an integrated, inline wizard which allows a user to type in a search term associated with a goal they would like to accomplish using the application and, responsively, have displayed multiple different selectable choices that pertain to their search term, wherein at least a portion of an inline wizard user interface is displayed within the application user interface, and wherein the inline wizard is configured to:
present additional information responsive to a mouse being hovered over a particular choice; and
provide a guided help mode which guides a user through steps that are to be accomplished in order to take a particular action.

20. The one or more computer-readable storage media of claim 19, wherein the multiple different selectable choices are displayed entirely within a ribbon of the application user interface.
